(19) United States
(12) Patent Application Publication
(10) Pub. No.: US 2023/0088157 A1
(43) Pub. Date: Mar. 23, 2023

(54) ANOMALY SCORE CALCULATION APPARATUS, ANOMALOUS SOUND DETECTION APPARATUS, AND METHODS AND PROGRAMS THEREFOR

(71) Applicant: NIPPON TELEGRAPH AND TELEPHONE CORPORATION, Tokyo (JP)

(72) Inventors: Yuma KOIZUMI, Tokyo (JP); Shoichiro SAITO, Tokyo (JP)

(73) Assignee: NIPPON TELEGRAPH AND TELEPHONE CORPORATION, Tokyo (JP)

(21) Appl. No.: 17/794,537

(22) PCT Filed: Jan. 28, 2020
(86) PCT No.: PCT/JP2020/002872

§ 371 Date: Jul. 21, 2022

(51) Int. Cl. G01M 99/00; G06N 3/08

(52) U.S. Cl. CPC G01M 99/005; G06N 3/08

(57) ABSTRACT

An anomaly degree calculation device 200 includes an anomaly degree calculation unit 201 that calculates an anomaly degree on a basis of a feature amount extracted from target data that is a calculation target of the anomaly degree. The anomaly degree calculation unit 201 calculates the anomaly degree on a basis of a similarity degree of the target data and registration data registered in advance. The similarity degree is calculated in consideration of a degree to which a frame constituting the target data and a frame constituting the registration data are similar to each other.

### TECHNICAL FIELD

The present invention relates to a technique of calculating an anomaly degree or a technique of detecting an anomalous sound.

### BACKGROUND ART

First, a conventional technique of unsupervised anomalous sound detection is described. The unsupervised anomalous sound detection is a technique of determining whether a state of an object (such as an industrial machine) that has emitted an observation signal X∈R^{T×Ω} is normal or anomalous (for example, see Non-Patent Literature 1). Here, although the form of X is not particularly limited, the discussion is advanced hereinafter assuming that X is one obtained by subjecting the observation signal to a time-frequency analysis. That is, X is a logarithmic amplitude spectrogram of the observation signal or the like, T represents the number of time frames, and Ω represents the number of frequency bins. In the anomalous sound detection, the monitoring target is determined to be anomalous if the anomaly degree calculated from X is higher than a threshold ϕ defined in advance, and the monitoring target is determined to be normal if the anomaly degree is lower than the threshold ϕ.

$$\begin{matrix}[ Math . 1 ] & \\ Z ( X ; {θ}_{a} , φ ) \{ \begin{matrix}Normal & ( A ( X ; {θ}_{a} ) < φ ) \\ Anomaly & ( A ( X ; {θ}_{a} ) ≧ φ )\end{matrix} & ( 1 )\end{matrix}$$

Here, A: R^{T×Ω}→R is an anomaly degree calculator having a parameter θₐ. In recent years, a method utilizing an autoencoder (AE) is known as an anomaly degree calculation method utilizing deep learning. For example, see Non-Patent Literatures 2 to 4. The anomaly degree calculation method utilizing the AE is as follows. The AE (X; θₐ) can be implemented by, for example, assuming X as an image, converting X into a low-dimensional vector z using a convolutional neural network, and further, restoring z into a matrix of T×Ω using a deconvolutional neural network. In this case, θₐ is a parameter of the convolutional neural network and the deconvolutional neural network.

$$\begin{matrix}[ Math . 2 ] & \\ A ( X ; {θ}_{a} ) = \frac{1}{T} {‖ X - AE ( X ; {θ}_{a} ) ‖}_{F}^{2} & ( 2 )\end{matrix}$$

Here, ∥⋅∥_{F} is a Frobenius norm of ⋅. In order to learn θₐ such that only normal data is used as learning data and that the anomaly degree of the normal data is made lower, θₐ is learned such that the average reconstruction error of the normal data is minimized.

$$\begin{matrix}[ Math . 3 ] & \\ {L}_{{θ}_{a}}^{A E} = \frac{1}{N} {{\sum }_{n = 1}}^{N} A ( {X}_{n}^{-} ; {θ}_{a} ) & ( 3 )\end{matrix}$$

Here, N is a mini-batch size, and Xₙ⁻ is the n^{th} normal data in a mini-batch.

Next, registered anomalous sound detection is described. A problem of the unsupervised anomalous sound detection utilizing the AE lies in overlooking of an anomalous sound. The learning of θₐ utilizing Expression (3) has a function of making the anomaly degree of a normal sound lower, but does not guarantee an increase in the anomaly degree of an anomalous sound. Therefore, in the case where the AE is completely generalized, not only a normal sound but also an anomalous sound becomes reconstructed, and the anomaly degree of an anomalous sound becomes lower as a result, so that such overlooking occurs. Because there is a possibility that overlooking of an anomaly leads to a serious accident, if an anomalous sound has once been overlooked, the system needs to be updated such that a similar error is avoided thereafter.

A method for realizing this includes a method utilizing a detector S: R^{T×Ω}→R that detects only detection of a specific anomalous sound with high accuracy. S may also be referred to as a “registered sound detector.” S is also a function S (X; θₛ) that returns a high value in the case where a registered anomalous sound M∈R^{T×Ω} and X are similar to each other. That is, the registered sound detector is executed in parallel with the unsupervised anomaly detector, output scores of the two are integrated, and a new anomaly degree is calculated.

[Math. 4]

A′(X;74 )=A(X; θₐ)+γS(S; θₛ) (4)

Here, θₛis a parameter of S, and γ≥0 is a weight of S. For convenience of the calculation, it is assumed in the following discussion that 0≤S≤1.

### CITATION LIST

### Non-Patent Literature

Non-Patent Literature 1: V. Chandola, A. Banerjee, and V. Kumar “Anomaly detection: A survey,” ACM Computing Surveys, 2009.

Non-Patent Literature 2: R. Chalapathy and S. Chawla, “Deep Learning for Anomaly Detection: A Survey,” arXivpreprint, arXiv: 1901.03407, 2019.

Non-Patent Literature 3: Y. Koizumi, S. Saito, H. Uematsu, Y. Kawachi, and N. Harada, “Unsupervised Detection of Anomalous Sound based on Deep Learning and the Neyman-Pearson Lemma,” IEEE/ACM Transactions on Audio, Speech, and Language Processing, Vol. 27-1, pp. 212-224, 2019.

Non-Patent Literature 4: Y. Koizumi, S. Saito, M. Yamaguchi, S. Murata, and N. Harada, “Batch Uniformization for Minimizing Maximum Anomaly Score of DNN-based Anomaly Detection in Sounds,” Proc. of IEEE Workshop on Applications of Signal Processing to Audio and Acoustics (WASPAA), 2019.

Non-Patent Literature 5: Y. Koizumi, S. Murata, N. Harada, S. Saito, and H. Uematsu, “SNIPER: Few-shot Learning for Anomaly Detection to Minimize False-Negative Rate with Ensured True-Positive Rate,” in Proc. of International Conference on Acoustics, Speech, and Signal Processing (ICASSP), 2019.

### SUMMARY OF THE INVENTION

### Technical Problem

In Non-Patent Literature 5, S is designed on the basis of a square error of: M compressed by one compression matrix; and X. The similarity degree based on such a simple square error has the following problem. That is, an anomalous sound can be detected with high accuracy in the case where M and X substantially coincide with each other. However, an anomalous sound cannot be detected, for example, in the case where a time-frequency structure (spectrogram) slightly changes due to a change in surrounding noises and a change in trouble portions in spite of the fact that M and X have a similar anomaly. Hence, in the conventional study, the length of a registered sound is limited to approximately 300 ms, leading to a problem that a continuous anomalous sound caused by an anomaly of a motor rotation speed or the like is difficult to be detected while a sudden sound such as a hitting sound of things can be detected with high accuracy.

The present invention has an object to provide an anomaly degree calculation device that calculates an anomaly degree for detecting an anomalous sound with higher accuracy than before, an anomaly degree calculation device that detects an anomalous sound with higher accuracy than before, methods therefor, and programs therefor.

### Means for Solving the Problem

An anomaly degree calculation device according to an aspect of this invention includes an anomaly degree calculation unit that calculates an anomaly degree on a basis of a feature amount extracted from target data that is a calculation target of the anomaly degree, the anomaly degree calculation unit calculates the anomaly degree on a basis of a similarity degree of the target data and registration data registered in advance, and the similarity degree is calculated in consideration of a degree to which a frame constituting the target data and a frame constituting the registration data are similar to each other.

An anomaly degree calculation device according to an aspect of this invention includes: the anomaly degree calculation device; and a determination unit that determines that an anomalous sound occurs, in a case where an anomaly degree calculated by the anomaly degree calculation device is higher than a predetermined threshold.

### Effects of the Invention

An anomaly degree for detecting an anomalous sound with higher accuracy than before can be calculated. An anomalous sound can be detected with higher accuracy than before.

### BRIEF DESCRIPTION OF DRAWINGS

FIG. 1 is a diagram illustrating an example of a function configuration of a learning device.

FIG. 2 is a diagram illustrating an example of a processing procedure of a learning method.

FIG. 3 is a diagram illustrating an outline of an example of calculation of a similarity degree.

FIG. 4 is a diagram illustrating an example of function configurations of an anomalous sound detection device and an anomaly degree calculation device.

FIG. 5 is a diagram illustrating an example of processing procedures of an anomalous sound detection method and an anomaly degree calculation method.

FIG. 6 is a diagram illustrating an example of experimental results.

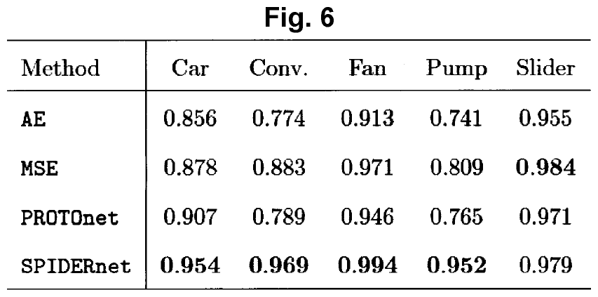

FIG. 7 is a diagram illustrating an example of a function configuration of a computer.

### DESCRIPTION OF EMBODIMENTS

Hereinafter, an embodiment of the present invention is described in detail. Note that constituent units having the same function are denoted by the same reference sign in the drawings, and a redundant description is omitted.

### Technical Background

It is considered to exercise ingenuity on the design method of S. Specifically, it is considered to absorb a shift in a time-frequency structure by (i) utilizing not one compression matrix like the conventional study but a high-order feature amount calculator based on a neural network and (ii) utilizing an attention mechanism. For the attention mechanism, see Reference Literature 1.

Reference Literature 1: A. Vaswani, N. Shazeer, N. Parmar, J. Uszkoreit, L. Jones, A. N. Gomez, L. Kaiser, and I. Polosukhin, “Attention Is All You Need,” in Proc. 31st Conference on Neural Information Processing Systems (NIPS), 2017.

A learnable parameter is θₛ={θ_{f}, θ_{w}}. Here, θ_{f} is a parameter of a feature amount calculator F: R^{T×Ω}→R^{T×Dw}. Moreover, θ_{w} is {W_{h, q}, W_{h, k}, W_{h, v}}ₕ₌1^{H} that is a parameter of a multi-head attention (MHA). Note that H is the number of multi-heads. H is an integer equal to or more than 1. For the multi-head attention (MHA), see Reference Literature 1.

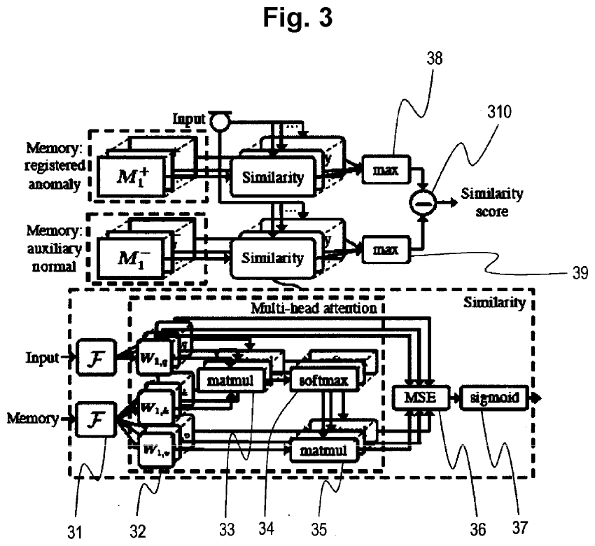

In the MHA, a plurality of attention mechanisms is prepared, and roles are respectively assigned to the mechanisms. Here, the roles respectively assigned to the heads are described. As illustrated in FIG. 3, a feature amount extracted by F is divided into H partial feature amounts in order from the top, and the divided partial feature amounts are respectively assigned to the heads. Empirically in many cases, features of high-frequency components are reflected in an upper portion of the feature amount extracted by F, and features of low-frequency components are reflected in a lower portion thereof. Accordingly, in order to enable assignment to the attention mechanisms for each frequency component, such a way of dividing is adopted. Further, such explicit control as assignment to the heads for each frequency component may be performed.

S uses I pieces of anomaly data {Mᵢ⁺∈R^{T×Ω}}ᵢ₌₁^{I} and J pieces of auxiliary normal data {Mⱼ⁻∈R^{T×Ω}}ⱼ₌₁^{J} to return a high value in the case where X is similar to any of {Mᵢ⁺}ᵢ₌₁^{I} or the case where X is similar to none of {Mⱼ⁻}ⱼ₌₁^{J}. I and J are integers equal to or more than 1.

A specific calculation method of the above description is described below. For the sake of simplicity of characters, in a process of calculating the similarity degree of one given registered sample (that is, any one of {Mᵢ⁺}ᵢ₌₁^{I} and {Mⱼ⁻}ⱼ₌₁^{J}) and X, superscripts and subscripts are omitted, and a simple M is used. First, a feature amount is extracted by F, and query, key, and value in the MHA are calculated in the following manner. Here, F is designed such that the feature amount extracted by F is smoothed. The “smoothing” means “leveling” and/or “expanding” in other words. Accordingly, F is configured using a convolutional neural network, a recurrent neural network, and the like.

[Math. 5]

Qₕ=F(X; θ_{f})W_{h,q}∈R^{T×D}^{ₛ} (5)

Kₖ=F(M; θ_{f})W_{k,k}∈R^{T×D}^{ₛ} (6)

Vₖ=F(M; θ_{f})W_{h,v}∈R^{T×D}^{ₛ} (7)

Here, the size of each of the matrices {W_{h, q}, W_{h, k}, W_{h, v}}ₕ₌1^{H} is D_{w}×Dₛ. The processing of Expression (5) to Expression (7) corresponds to the processing of 31 and 32 in FIG. 3.

Subsequently, in order to absorb a shift in a time-frequency structure, Vₕ is multiplied by an attention matrix Aₕ∈R^{T×T} representing the similarity degree of M and X for each frame. The processing of Expression (8) corresponds to the processing of 33 and 34 in FIG. 3. The processing of Expression (9) corresponds to the processing of 35 in FIG. 3.

[Math. 6]

Aₕ=softmax[λQₖKₕ^{T}]∈R^{T×T} (8)

Cₕ=AₖVₖ∈R^{T×D}^{ₛ} (9)

Here, λ=D_{w}^{-1/2}. Softmax is a function that converts the matrix such that the sum of the respective elements in the rows of the matrix is 1. That is, Σ_{τ=1}^{T}Aₕ[t, τ]=1. Aₕ[t, τ] is an element in the t^{th} row and the τ^{th} column of the matrix Aₕ. Aₕ[t, :] represents the similarity degree of embedding Qₕ[t, :] of an observation signal in the t^{th} time frame and every time frame of Kₕ. Aₕ[t, :] is a vector constituted by the element in the t^{th} row of the matrix Aₕ. Qₕ[t, :] is a vector constituted by the element in the t^{th} row of the matrix Qₕ. Therefore, it can be said that Aₕ[t, :] extracts a time frame similar to Qₕ[t, :] from Vₕ and outputs Cₕ. In this way, it can be believed that a shift in a time-frequency structure can be absorbed in consideration of the degree to which the frame Qₕ[t, :] constituting target data and the frame Kₕ^{T}[t, :] constituting registration data are similar to each other, more specifically, in consideration of the degree to which each frame Qₕ[t, :] constituting the target data and each frame Kₕ^{T}[t, :] constituting the registration data are similar to each other.

Then, the high-order similarity degree of X and M at the time t is calculated in the following manner.

$$\begin{matrix}[ Math . 7 ] & \\ {S ( X , M )}_{t} = 2 \cdot σ [ - {{\sum }_{h = 1}}^{H} {g}_{h , t}^{T} {g}_{h , t} ] & ( 10 )\end{matrix}$$

$${g}_{h , t} = {C}_{h} [ t , : ] - {Q}_{h} [ t , : ] \qquad ( 11 )$$

The processing of Expression (10) and Expression (11) corresponds to the processing of 36 and 37 in FIG. 3. Note that σ[⋅] is a sigmoid function. Cₕ[t, :] is a vector constituted by the element in the t^{th} row of the matrix Cₕ. The processing of 32 to 37 in FIG. 3 corresponds to the processing of Similarity in an upper portion of FIG. 3.

Lastly, the similarity degree S (X; θₛ) is calculated in the following manner. The processing of Expression (12) corresponds to the processing of 310 in FIG. 3. The processing of Expression (13) corresponds to the processing of 38 in FIG. 3. The processing of Expression (14) corresponds to the processing of 39 in FIG. 3.

$$\begin{matrix}[ Math . 8 ] & \\ S ( X ; {θ}_{s} ) = \frac{1}{2 T} {{\sum }_{t}}^{T} {{S}^{+} ( X )}_{t} + 1 & ( 12 )\end{matrix}$$

$${{S}^{+} ( X )}_{t} = {max [ {S ( X , {M}_{i}^{+} )}_{t} ]}_{\text{?}} \qquad ( 13 )$$

$${{S}^{-} ( X )}_{t} = {max [ 5 {( X , {M}_{j}^{-} )}_{t} ]}_{\text{?}} \qquad ( 14 )$$

$$\text{?} \text{indicates text missing or illegible when filed}$$

It is sufficient for the parameter θₛ to learn so as to minimize some kind of cost function, and the simplest cost function is given below.

$$\begin{matrix}[ Math . 9 ] & \\ {L}_{{θ}_{s}}^{SPD} = \frac{1}{N} {{\sum }_{n = 1}}^{N} S ( {X}_{n}^{-} ; {θ}_{s} ) - S ( {X}_{n}^{+} ; {θ}_{s} ) & ( 15 )\end{matrix}$$

Here, {Xₙ⁻}ₙ₌₁^{N} and {Xₙ⁺}ₙ₌₁^{N} are mini-batches of normal data and anomaly data. In the case where {Xₙ⁺}ₙ₌₁^{N} cannot be obtained in advance, {Xₙ⁺}ₙ₌₁^{N} may be pseudo-generated according to a method similar to that of Non-Patent Literature 5. Moreover, the following cost may be added as a regularization term concerning Aₕ.

$$\begin{matrix}[ Math . 10 ] & \\ R = {R}^{Y} + {R}^{c} & ( 16 )\end{matrix}$$

$${R}^{y} = \frac{1}{TH} {{\sum }_{h = 1}}^{H} {{\sum }_{t = 1}}^{T} 1 - {{\sum }_{τ = 1}}^{T} {A}_{h}^{2} [ t , τ ] \qquad ( 17 )$$

$${R}^{c} = \frac{1}{TH} {{\sum }_{h = 1}}^{H} {{\sum }_{t = 1}}^{T} {( {{\sum }_{τ = 1}}^{T} {A}_{h} [ t , τ ] - 1 )}^{2} \qquad ( 18 )$$

Here, R^{r} acts such that each row in Aₕ is sparse, and R^{c} acts such that every time frame in M is selected at the time of comparison between X and M. That is, R is a regularization term that causes Aₕ to act such that the respective time frames of X and M are in one-to-one correspondence.

### Learning Device and Method

Hereinafter, a learning device and method are described.

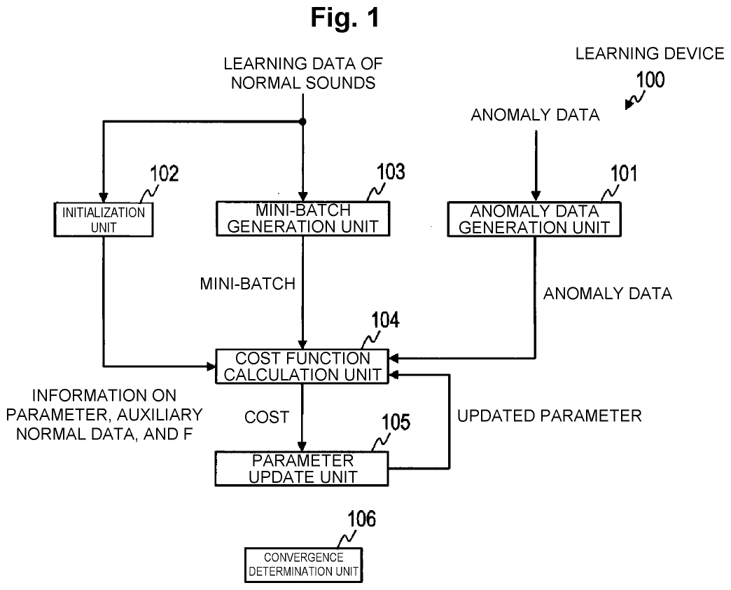

As illustrated in FIG. 1, a learning device 100 includes, for example, an anomaly data generation unit 101, an initialization unit 102, a mini-batch generation unit 103, a cost function calculation unit 104, a parameter update unit 105, and a convergence determination unit 106.

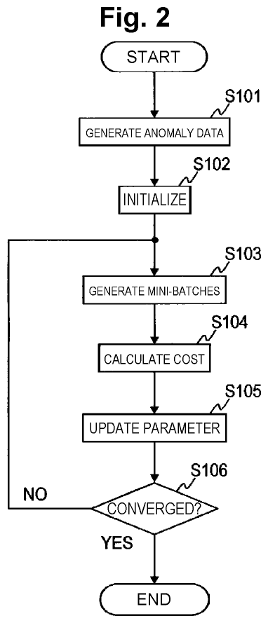

The learning method is realized, for example, by respective constituent units of the learning device 100 performing the processing of Step S101 to Step S106 described below and illustrated in FIG. 2.

Hereinafter, the respective constituent units of the learning device are described.

Various parameters, learning data of normal sounds, and anomaly data that is registration data Mᵢ₊ of anomalous sounds are input to the learning device 100.

For example, the various parameters are set to approximately N=100, H=3, γ=100, I=J=5, D_{w}=64, and D₅=35. X may be compressed by log Mel filter bank amplitude and the like. The number of Mel filter banks at that time may be set to approximately 64. The various parameters input to the learning device 100 are used as appropriate by each unit of the learning device 100.

### Anomaly Data Generation Unit 101

The anomaly data input to the learning device 100 is input to the anomaly data generation unit 101.

In the case where the number of pieces of the input anomaly data is less than I, the anomaly data generation unit 101 pseudo-generates anomaly data according to a method similar to the method described in Non-Patent Literature 5, and generates the anomaly data

The generated anomaly data {Mᵢ⁺}ᵢ₌₁^{I} is output to the cost function calculation unit 104.

Note that, in the case where the number of pieces of the input anomaly data Mᵢ₊ is equal to or more than I, the anomaly data generation unit 101 outputs the input anomaly data Mᵢ₊ without any change to the cost function calculation unit 104.

### Initialization Unit 102

The learning data of the normal sounds input to the learning device 100 is input to the initialization unit 102.

The initialization unit 102 initializes S (Step S102). For example, the initialization unit 102 initializes the parameter θₛ using a random number. Moreover, the initialization unit 102 makes a random selection from the input learning data of the normal sounds, to thereby generate the auxiliary normal data {Mⱼ⁻}ⱼ₌₁^{J} (Step S102).

The initialization unit 102 configures and initializes F using, for example, a convolutional neural network, a recurrent neural network, and the like.

Information on the parameter, the auxiliary normal data {Mⱼ⁻}ⱼ₌₁^{J}, and F obtained by the initialization unit 102 is output to the cost function calculation unit 104.

### Mini-Batch Generation Unit 103

The learning data of the normal sounds input to the learning device 100 is input to the mini-batch generation unit 103.

The mini-batch generation unit 103 generates the mini-batch {Xₙ⁺}ₙ₌₁^{N} of the anomalous sounds according to a method similar to the method described in Non-Patent Literature 5, and generates the mini-batch {Xₙ⁻}ₙ₌₁^{N} of the normal sounds from the learning data of the normal sounds (Step S103). The generated mini-batches {Xₙ⁺}ₙ₌₁^{N} and {Xₙ⁻}ₙ₌₁^{N} are output to the cost function calculation unit 104.

### Cost Function Calculation Unit 104

The anomaly data, the information on the parameter, the auxiliary normal data {Mⱼ⁻}ⱼ₌₁^{J}, and F obtained by the initialization unit 102, and the mini-batches generated by the mini-batch generation unit 103 are input to the cost function calculation unit 104.

The cost function calculation unit 104 calculates a cost on the basis of cost functions such as Expression (15) (Step S104). The calculated cost is output to the parameter update unit 105.

### Parameter Update Unit 105

The cost calculated by the cost function calculation unit 104 is input to the parameter update unit 105.

The parameter update unit 105 calculates a gradient concerning θₛ of the cost function using the input cost, and updates the parameter according to a gradient method (Step S105). The updated parameter is output to the cost function calculation unit 104.

### Convergence Determination Unit 106

The convergence determination unit 106 determines whether a predetermined convergence condition is satisfied (Step S106). For example, in the case where the number of updates of the parameter reaches a predetermined number of times, the convergence determination unit 106 determines that the predetermined convergence condition is satisfied.

In the case where the predetermined convergence condition is satisfied, the learned parameter θₛ that is the parameter last obtained by updating, the anomaly data {Mᵢ⁺}ᵢ₌₁^{I}, and the auxiliary normal data {Mⱼ⁻}ⱼ₌₁^{J} are output.

In the case where the predetermined convergence condition is not satisfied, the processing returns to Step 103.

In this way, the learning is performed.

Note that, in the learning device and method, the learning may be performed further on the basis of a normal model A. In this case, the cost function calculation unit 104 calculates the cost on the basis of, for example, Expression (19) given below, instead of Expression (15) (Step S104).

$$\begin{matrix}[ Math . 11 ] & \\ {L}_{{θ}_{s}}^{SPD} = \frac{1}{N} {{\sum }_{n = 1}}^{N} {A}^{′} ( {X}_{n}^{-} ; {θ}_{s} ) - {A}^{′} ( {X}_{n}^{+} ; {θ}_{s} ) & ( 19 )\end{matrix}$$

Here, A′ is defined by Expression (4).

### Anomaly Degree Detection Device and Method, Anomaly Degree Calculation Device and Method

Hereinafter, an anomaly degree detection device and method and an anomaly degree calculation device and method are described.

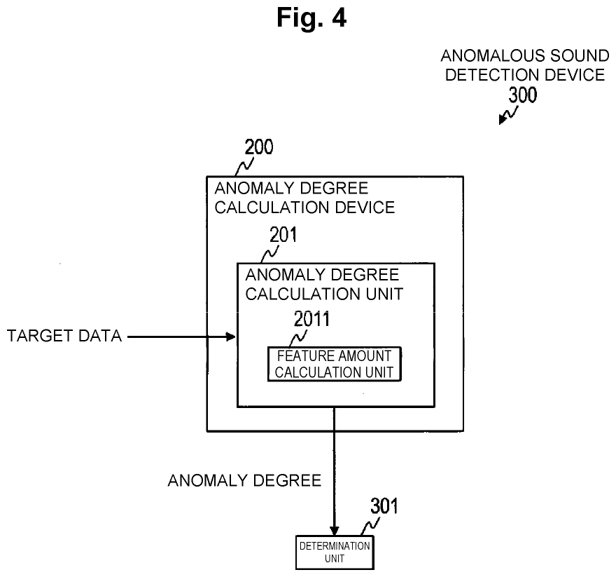

As illustrated in FIG. 4, an anomaly degree detection device 300 includes, for example, an anomaly degree calculation device 200 and a determination unit 301. The anomaly degree calculation device 200 includes, for example, an anomaly degree calculation unit 201. The anomaly degree calculation unit 201 includes, for example, a feature amount calculation unit 2011.

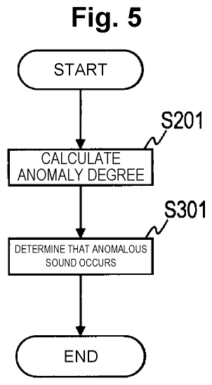

The anomaly degree calculation method is realized, for example, by each unit of the anomaly degree calculation device performing the processing of Step S201 described below and illustrated in FIG. 5.

The anomaly degree detection method is realized, for example, by respective constituent units of the anomaly degree detection device 300 performing the processing of Step S201 to Step S301 described below and illustrated in FIG. 5.

Hereinafter, the respective constituent units of the anomaly degree calculation device 200 and the anomaly degree detection device 300 are described.

### Anomaly Degree Calculation Unit 201

Target data that is a calculation target of an anomaly degree is input to the anomaly degree calculation unit 201 of the anomaly degree calculation device 200. The target data is, in other words, an observation signal X.

The anomaly degree calculation unit 201 calculates an anomaly degree on the basis of a feature amount extracted from the target data that is the calculation target of the anomaly degree (Step S201). The calculated anomaly degree is output to the determination unit 301.

The anomaly degree calculation unit 201 may include the feature amount calculation unit 2011 that extracts the feature amount from the target data. In this case, the anomaly degree calculation unit 201 calculates the anomaly degree on the basis of the anomaly degree extracted by the feature amount calculation unit 2011.

The anomaly degree calculation unit 201 calculates the anomaly degree on the basis of the similarity degree of the target data and registration data registered in advance. The registration data is the anomaly data {Mᵢ⁺}ᵢ₌₁^{I} and the auxiliary normal data {Mⱼ⁻}ⱼ₌₁^{J} that are output by the learning device 100. Moreover, the anomaly degree calculation unit 201 calculates the anomaly degree on the basis of the learned parameter θₛ output by the learning device 100.

The anomaly degree calculation unit 201 calculates, for example, the similarity degree A′ (X; θ) defined by Expression (4). In the calculation process of Expression (4), S (X; θₛ) defined by Expression (12) is calculated. In the calculation process of Expression (12), the feature amounts F (X; θ_{f}) and F (X; θ_{f}) appearing in Expression (5) to Expression (7) are calculated. This calculation of the feature amounts F (X; θ_{f}) and F (X; θ_{f}) is performed by the feature amount calculation unit 201.

A (X; θₐ) in Expression (4) is defined by, for example, Expression (2).

As described above, the feature amount F is a smoothed feature amount.

As described above, the degree to which the frame constituting the target data and the frame constituting the registration data are similar to each other is considered according to Expression (8) and Expression (9). More specifically, the degree to which each frame constituting the target data and each frame constituting the registration data are similar to each other is considered.

Hence, it can be said that the similarity degree calculated by the anomaly degree calculation unit 201 is calculated in consideration of the degree to which the frame constituting the target data and the frame constituting the registration data are similar to each other. More specifically, it can be said that the similarity degree calculated by the anomaly degree calculation unit 201 is calculated in consideration of the degree to which each frame constituting the target data and each frame constituting the registration data are similar to each other.

As described above, S (in other words, S (X; θₛ) defined by Expression (12)) uses I pieces of anomaly data {Mᵢ⁺∈R^{T×Ω}}ᵢ₌₁^{I} and J pieces of auxiliary normal data {Mⱼ⁻∈R^{T×Ω}}ⱼ₌₁^{J} to return a high value in the case where X is similar to any of {Mᵢ⁺}ᵢ₌₁^{I} or the case where X is similar to none of {Mⱼ⁻}ⱼ₌₁^{J}. Hence, it can be said that the anomaly degree calculated by the anomaly degree calculation unit 201 is calculated so as to: become higher as the similarity degree of the target data and the anomaly data becomes higher; and become higher as the similarity degree of the target data and the auxiliary normal data becomes lower.

### Determination Unit 301

The anomaly degree calculated by the anomaly degree calculation device 200 is input to the determination unit 301.

In the case where the anomaly degree calculated by the anomaly degree calculation device 200 is higher than a predetermined threshold, the determination unit 301 determines that an anomalous sound occurs (Step S301). The predetermined threshold is set as appropriate such that a desired result can be obtained.

In the conventional registered sound detection, the similarity degree index based on a simple MSE is utilized, and hence it is difficult to register a continuous anomalous sound. In view of this, for example, a shift in a time-frequency structure is absorbed by (i) utilizing not one compression matrix like the conventional study but a high-order feature amount calculator based on a neural network and (ii) utilizing the attention mechanism (Reference Literature 1), whereby various anomalous sounds can be registered and anomalous sounds can be detected with high accuracy.

### Experimental Results

Five experiments are given as examples showing the effectiveness of the present invention (SPIDERnet). In these examples, experiments were performed on operation data of a total of five machines from published datasets ToyADMOS (Reference Literature 2) and MIMII (Reference Literature 3). Moreover, in addition to the present invention (SPIDERnet), the method of Non-Patent Literature 5 that is an unsupervised anomalous sound detector (AE) and the method (PROTOnet) of Reference Literature 4 were compared.

Reference Literature 2: Y. Koizumi, S. Saito, H. Uematsu, N. Harada, and K. Imoto, “ToyADMOS: A dataset of miniature-machine operating sounds for anomalous sound detection,” Proc. of the Work shop on Applications of Signal Processing to Audio and Acoustics (WASPAA), 2019.

Reference Literature 3: H. Purohit, R. Tanabe, K. Ichige, T. Endo, Y. Nikaido, K. Suefusa, and Y. Kawaguchi, “MIMII dataset: Sound dataset for malfunctioning industrial machine investigation and inspection,” Proc. of the 4th Workshop on Detection and Classification of Acoustic Scenes and Events (DCASE), 2019.

Reference Literature 4: J. Pons, J. Serra, and X. Serra, “Training Neural Audio Classifiers with Few Data,” in Proc. of International Conference on Acoustics, Speech, and Signal Processing (ICASSP), 2019.

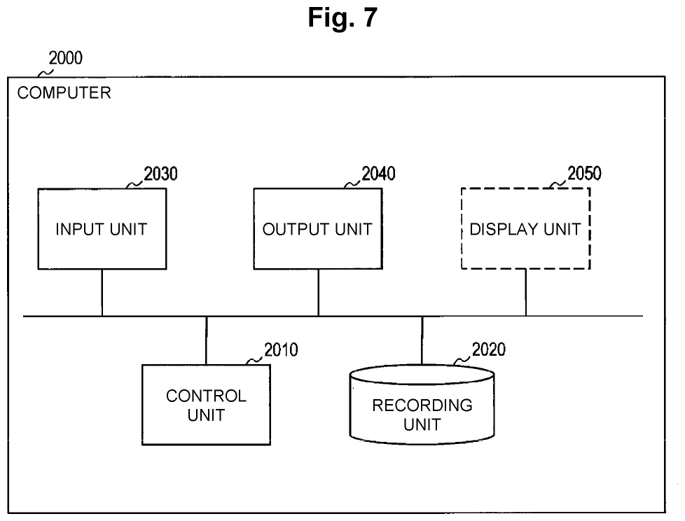

FIG. 7 illustrates scores of an area under the receiver operating characteristic curve (AUC). A higher value of this score means higher performance. Note that Car and Conv. in FIG. 7 respectively show results of toy-car and toy-conveyor in the ToyADMOS dataset, and Fan, Pump, and Slider in FIG. 7 respectively show results of fans, pumps, and slide rails in the MIMII dataset. For most of the machines, the present invention (SPIDERnet) is superior in performance to the conventional methods and other methods. Moreover, even for Slider in which the present invention (SPIDERnet) is inferior to tMSE, there is little difference in performance. MSE that is superior in Slider to the present invention is significantly inferior in the other datasets to the scores of the present invention, and this means that anomalous sounds other than sudden sounds cannot be stably detected, which is described above as a problem point. From the above, it can be understood that the present invention is effective in registered anomalous sound detection.

### Modified Examples

Although the embodiment of the present invention is described hereinabove, specific configurations are not limited to the embodiment, and it goes without saying that designs and the like that are changed as appropriate within the range not departing from the scope of the present invention are also included in the present invention.

The various types of processing described in the embodiment are not limitedly executed in chronological order of the described items, and may be executed in parallel or individually in accordance with the needs or the processing performance of the device that executes the processing.

For example, constituent units of respective devices may exchange data directly, or may exchange data via a storage unit not illustrated.

### Program, Recording Medium

In the case where the various processing functions of each device described above are realized by a computer, the processing contents of the functions of each device are described using a program. Then, this program is executed by the computer, whereby the various processing functions of each device described above are realized on the computer. For example, the above-mentioned various types of processing can be implemented by causing a recording unit 2020 of a computer illustrated in FIG. 7 to read thereon the program to be executed and causing a control unit 2010, an input unit 2030, an output unit 2040, and the like of the computer to operate.

The program used to describe the processing contents can be recorded on a computer-readable recording medium. The computer-readable recording medium may be in any form, for example, a magnetic recording device, an optical disk, an magnetooptical recording medium, and a semiconductor memory.

Moreover, this program is distributed by, for example, selling, assigning, lending, and the like a portable recording medium such as a DVD and a CD-ROM on which this program is recorded. Further, it is possible to adopt a configuration in which this program is distributed by storing this program in a storage device of a server computer and transferring this program via a network from the server computer to another computer.

For example, first, the computer that executes such a program once stores the program recorded on the portable recording medium or the program transferred from the server computer, into its own storage device. Then, at the time of executing processing, this computer reads out the program stored in its own storage device, and executes the processing according to the read-out program. Moreover, as other execution modes of this program, the computer may read out the program directly from the portable recording medium, and may execute the processing according to the read-out program, and further, this computer may sequentially execute the processing according to the received program each time the program is transferred thereto from the server computer. Moreover, it is possible to adopt a configuration in which, without transferring the program from the server computer to this computer, the above-mentioned processing is executed by realizing the processing function on the basis of only an execution instruction and result acquisition thereof, which is a service of so-called ASP (Application Service Provider) type. Note that the program according to this mode includes program-equivalent information used for processing by an electronic computer (such as data that is not a direct command to be given to the computer but has a property of defining the processing of the computer).

Moreover, although the present device is configured by executing the predetermined program on the computer according to this mode, at least part of these processing contents may be realized in the form of hardware.

1. An anomaly degree calculation device comprising a processor configured to execute a method comprising
calculating an anomaly degree on a basis of a feature amount extracted from target data that is a calculation target of the anomaly degree, wherein
the calculating further comprises calculating the anomaly degree on a basis of a similarity degree of the target data and registration data registered in advance, and
the similarity degree is calculated in consideration of a degree to which each frame constituting the target data and each frame constituting the registration data are similar to each other.

2. The anomaly degree calculation device according to claim 1, wherein
the registration data is anomaly data and auxiliary normal data, and
the anomaly degree is calculated so as to:
become higher as a similarity degree of the target data and the anomaly data becomes higher, and
become higher as a similarity degree of the target data and the auxiliary normal data becomes lower.

3. The anomaly degree calculation device according to claim 1, wherein
the feature amount corresponds to a smoothed feature amount.

4. An anomalous sound detection device comprising a processor configured to execute a method comprising:
calculating an anomaly degree on a basis of a feature amount extracted from target data that is a calculation target of the anomaly degree, wherein
the calculating further comprises calculating the anomaly degree on a basis of a similarity degree of the target data and registration data registered in advance, and
the similarity degree is calculated in consideration of a degree to which each frame constituting the target data and each frame constituting the registration data are similar to each other; and
determining that an anomalous sound occurs, in a case where the anomaly degree is higher than a predetermined threshold.

5. An anomaly degree calculation method, comprising
calculating an anomaly degree on a basis of a feature amount extracted from target data that is a calculation target of the anomaly degree, wherein
the calculating further comprises calculating the anomaly degree on a basis of a similarity degree of the target data and registration data registered in advance, and
the similarity degree is calculated in consideration of a degree to which a frame constituting the target data and a frame constituting the registration data are similar to each other.

6. (canceled)

7. The anomaly degree calculation device according to claim 1, wherein the registration data include a combination of exemplary anomalous sounds and auxiliary normal sound.

8. The anomaly degree calculation device according to claim 1, wherein the target data represent an observation signal used for determining the anomaly degree.

9. The anomaly degree calculation device according to claim 1, the processor further configured to execute a method comprising:
extracting the feature amount from the target data using a high-order feature among calculation based on use of a neural network.

10. The anomaly degree calculation device according to claim 2, wherein the feature amount corresponds to a smoothed feature amount.

11. The anomaly degree calculation device according to claim 4, wherein
the registration data is anomaly data and auxiliary normal data, and
the anomaly degree is calculated so as to:
become higher as a similarity degree of the target data and the anomaly data becomes higher, and
become higher as a similarity degree of the target data and the auxiliary normal data becomes lower.

12. The anomaly degree calculation device according to claim 4, wherein
the feature amount corresponds to a smoothed feature amount.

13. The anomaly degree calculation device according to claim 4, wherein the registration data include a combination of exemplary anomalous sounds and auxiliary normal sound.

14. The anomaly degree calculation device according to claim 4, wherein the target data represent an observation signal used for determining the anomaly degree.

15. The anomaly degree calculation device according to claim 4, the processor further configured to execute a method comprising:
extracting the feature amount from the target data using a high-order feature among calculation based on use of a neural network.

16. The anomaly degree calculation device according to claim 11, wherein
the feature amount corresponds to a smoothed feature amount.

17. The anomaly degree calculation method according to claim 5, wherein
the registration data is anomaly data and auxiliary normal data, and
the anomaly degree is calculated so as to:
become higher as a similarity degree of the target data and the anomaly data becomes higher, and
become higher as a similarity degree of the target data and the auxiliary normal data becomes lower.

18. The anomaly degree calculation method according to claim 5, wherein
the feature amount corresponds to a smoothed feature amount.

19. The anomaly degree calculation method according to claim 5, wherein the registration data include a combination of exemplary anomalous sounds and auxiliary normal sound.

20. The anomaly degree calculation method according to claim 5, wherein the target data represent an observation signal used for determining the anomaly degree.

21. The anomaly degree calculation method according to claim 5, further comprising:
extracting the feature amount from the target data using a high-order feature among calculation based on use of a neural network.
